(19) United States
(12) Patent Application Publication
(10) Pub. No.: US 2025/0101803 A1
(43) Pub. Date: Mar. 27, 2025

(54) ELECTRIC CURTAIN

(71) Applicant: JEFF WH LI, IRVINE, CA (US)

(72) Inventor: JEFF WH LI, IRVINE, CA (US)

(21) Appl. No.: 18/373,350

(22) Filed: Sep. 27, 2023

(51) Int. Cl. E06B 9/72; E06B 9/42

(52) U.S. Cl. CPC E06B 9/72; E06B 9/42

(57) ABSTRACT

An electric curtain is provided, including a curtain fabric, and a curtain rod for rolling up the curtain fabric. A first induction coil is disposed at a position of the curtain rod opposite to a surface of the curtain fabric, the first induction coil is electrically connected to a battery disposed in the curtain rod, and the first induction coil is configured to be combined with a second induction coil configured with an external power supply to form an inductive charging device, so as to inductively charge the battery from the external power supply.

### FIELD OF THE DISCLOSURE

The present disclosure relates to the technical field of electric curtains, and more particularly to a roller blind type electric curtain.

### BACKGROUND OF THE DISCLOSURE

As shown in FIGS. 1 and 2, for a roller blind type electric curtain currently on the market, a driving motor of the curtain rod 1 is disposed inside the curtain rod 1, and one terminal 2 of the motor is exposed from the end of the curtain rod 1. A charging interface 3 is provided on a side of the terminal 2 of the motor, and a built-in battery is charged through the charging interface 3. After this type of electric curtain is mounted on a window frame, the terminal 2 of the motor will be blocked between an edge 5 of a curtain fabric and the window frame 4. In order to accommodate the charging interface 3, a length of the terminal 2 of the motor needs to be made larger. The length herein refers to a dimension in a direction of a rotation axis of the curtain rod 1. The longer terminal 2 causes a larger gap between the edge 5 of the curtain fabric and the window frame 4, thereby causing a significant leakage through the curtain.

### SUMMARY OF THE DISCLOSURE

The purpose of the present disclosure is to provide an electric curtain used to reduce a gap between an edge of a curtain fabric and a window frame and improve a light-shading capability of the curtain.

In order to solve the above-mentioned problems, the present disclosure provides an electric curtain, which includes a curtain fabric, and a curtain rod for rolling up the curtain fabric. A first induction coil is disposed at a position of the curtain rod opposite to a surface of the curtain fabric, the first induction coil is electrically connected to a battery disposed in the curtain rod, and the first induction coil is configured to be combined with a second induction coil configured with an external power supply to form an inductive charging device, so as to inductively charge the battery from the external power supply.

In preferred embodiments, the curtain rod includes a roller, and a motor disposed in the roller and configured to provide a rotational power to the roller. The first induction coil is fixed to the motor, and a position of the roller corresponding to the first induction coil is provided with a through hole.

In preferred embodiments, the second induction coil or a carrier of the second induction coil is magnetic.

In preferred embodiments, the first induction coil is further configured in a manner that after the electric curtain is mounted on a window frame, the first induction coil is located on a side of the curtain rod away from a wall or a side away from a glass.

In preferred embodiments, the motor has a terminal, the terminal has a first terminal surface perpendicular to a rotation axis of the curtain rod, the electric curtain includes a power switch, and the power switch is disposed on the first terminal surface.

In preferred embodiments, the motor has a terminal and the terminal has a first terminal surface perpendicular to a rotation axis of the curtain rod, the electric curtain includes a network configuration key, and the network configuration key is disposed on the first terminal surface.

In preferred embodiments, the electric curtain includes an antenna configured to receive remote control signals, and the antenna is disposed at a position of the curtain rod opposite to a surface of the curtain fabric.

Compared with the conventional technology, the present disclosure has at least the following beneficial effects.

The present disclosure uses the first induction coil as a charging interface of the electric curtain, and the first induction coil is disposed at the position of the curtain rod opposite to the surface of the curtain fabric. When charging, the external power source and the first induction coil on the curtain rod form the inductive charging device to inductively charge the built-in battery of the electric curtain, so that it is unnecessary to configure a charging interface at the terminal of the motor, a length of the terminal of the motor can be minimized, the gap between the edge of the curtain fabric and the window frame can be reduced, and the light-shading capability of the curtain can be improved.

### BRIEF DESCRIPTION OF THE DRAWINGS

FIG. 1 is a schematic structural diagram of a curtain rod of a conventional electric curtain;

FIG. 2 is an enlarged diagram of part A in FIG. 1;

FIG. 3 is schematic diagram of an electric curtain according to an embodiment;

FIG. 4 is a schematic diagram of a curtain rod;

FIG. 5 is a schematic exploded diagram of the curtain rod; and

FIG. 6 is a schematic diagram of a terminal of the curtain rod.

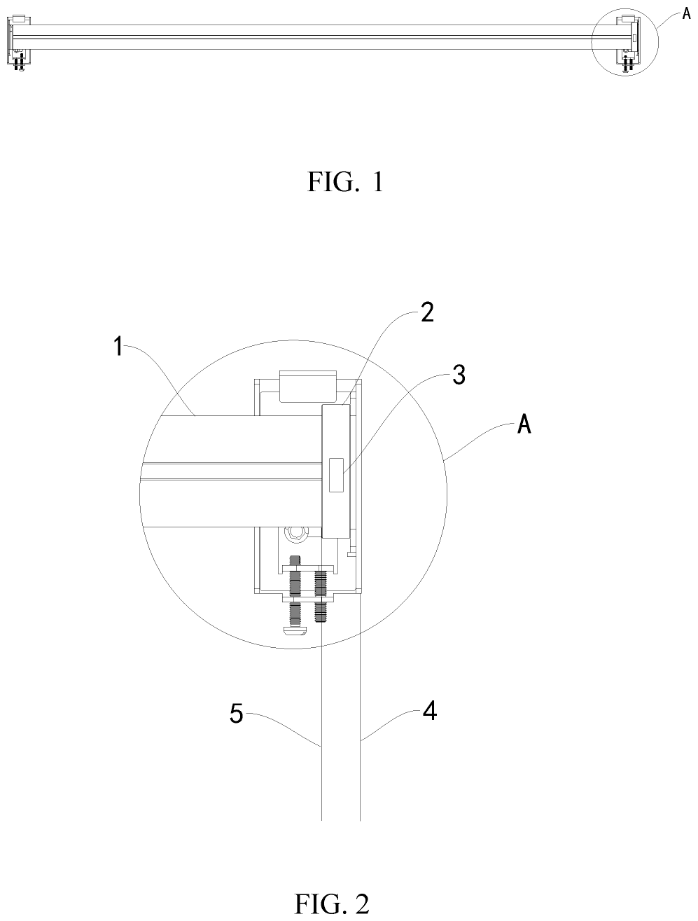

Reference numeral: 1, curtain rod; 11, roller; 12, motor; 13, bearing; 14, switch; 15, first terminal surface; 16, network configuration key; 2. terminal, 3, charging interface; 4, window frame; 5, edge of curtain fabric; 6, curtain fabric; 7, bracket; 8, first induction coil; 81, through hole.

### DETAILED DESCRIPTION OF THE EXEMPLARY EMBODIMENTS

The present disclosure will be described in detail below in conjunction with the accompanying drawings.

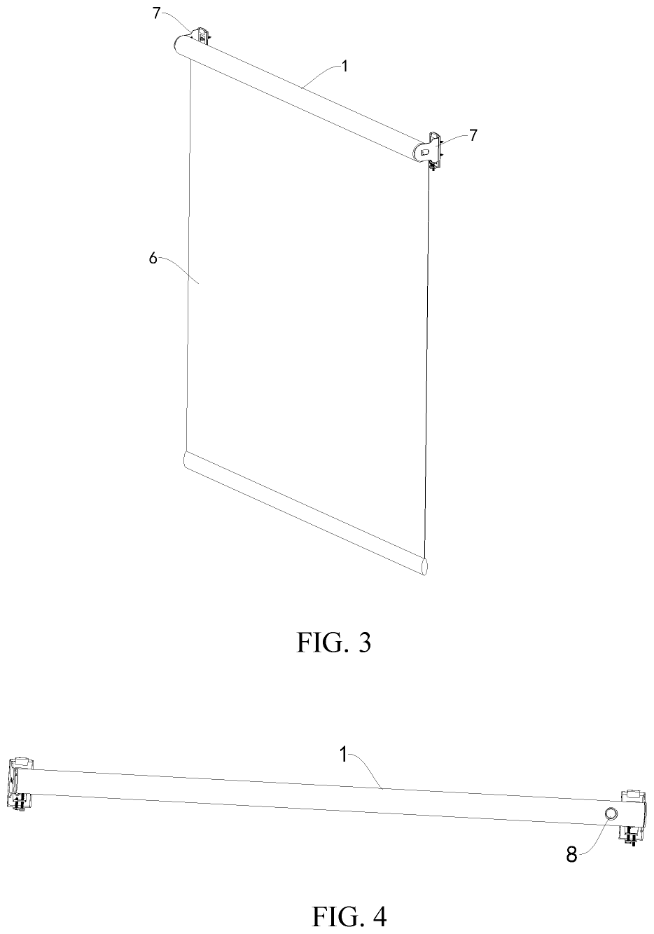

As shown in FIG. 3, an electric curtain of this embodiment comprises a curtain fabric 6 and a curtain rod 1. Two ends of the curtain rod 1 are supported on the bracket 7, and an upper end of the curtain fabric 6 is fixed on the curtain rod 1. When the curtain rod 1 rotates forward around its rotation axis, the curtain fabric 6 is gradually rolled onto the curtain rod 1, such that the curtain fabric 6 is in a retracted state. When the curtain rod 1 reversely rotates around its rotation axis, the curtain fabric 6 is unrolled from the curtain rod 1, such that the curtain fabric 6 is in an open state. The curtain fabric can be various known shading fabrics, and a material of the curtain fabric is not limited in the present disclosure.

FIG. 4 schematically shows a structure of the curtain rod 1. As shown in FIG. 4, the curtain rod 1 is provided with a first induction coil 8, and a position of the first induction coil 8 is opposite to a surface of the curtain fabric 6. That is, the first induction coil 8 is disposed on a body of the curtain rod 1 instead of being disposed on a terminal of a motor of the curtain rod.

The first induction coil 8 is electrically connected to a battery disposed in the curtain rod 1, and is used as a charging interface for the electric curtain.

When it is required to charge the electric curtain, a second induction coil of an external power supply is aligned with the first induction coil 8, the second induction coil is attached to the curtain rod 1 through the curtain fabric, the second induction coil and the first induction coil 8 are combined to form an inductive charging device. An electric energy from the external power supply is coupled to the first induction coil 8 through the induction charging device, and the battery of the electric curtain is charged through the first induction coil 8.

In the above embodiment, the first induction coil 8 is used as the charging interface of the electric curtain. The first induction coil 8 is arranged at a position of the surface of the curtain rod 1 opposite to the curtain fabric 6. During charging, the external power supply and the first induction coil 8 on the curtain rod 1 form the inductive charging device to inductively charge the battery disposed in the electric curtain, so that there is no need to configure a charging interface at the terminal of the motor. Accordingly, a length of the terminal of the motor can be made shorter. The length herein refers to a dimension in a direction of the rotation axis of the curtain rod 1, and the length of the terminal can be reduced to 1 mm generally. With reference to FIG. 2, the reduction of the length of the terminal 2 will reduce a gap between an edge 5 of the curtain fabric and a window frame 4, and a light-shading capability of the curtain can be improved.

In FIG. 4, the first induction coil 8 is disposed adjacent to a right bracket of the curtain rod 1. It can be understood that the position of the first induction coil 8 in an axial direction of the curtain rod 1 is not limited to the position shown in FIG. 4, and it can also be at other positions. For example, it can also be configured corresponding to a center position of the rotation axis of the curtain rod, or adjacent to a left bracket of the curtain rod, or other positions. In any case, the first induction coil 8 is not to be disposed at the terminal of the motor.

As an embodiment, the first induction coil 8 is further configured in a manner that when the electric curtain is mounted on the window frame, the first induction coil 8 is located on a side of the curtain rod 1 away from a wall or a side away from a glass. In this way, when the second induction coil is attached to the curtain rod 1 through the curtain fabric, a user's hand will not interfere with the wall or glass, so an operation of the electric curtain of the present embodiment is user-friendly.

As an embodiment, the second induction coil has a magnetic property, or a carrier of the second induction coil has a magnetic property. The curtain rod 1 includes a material that can be magnetically attracted, and the second induction coil is attracted to the curtain rod 1 due to a magnetic force.

Preferably, a motor having an iron casing is used as the motor of the curtain rod 1, so that the magnetic second induction coil can be attracted to the curtain rod 1 due to the magnetic force.

Since the combination of the second induction coil and the first induction coil 8 is realized by the magnetic attraction, no mechanical fixing structure is required, and after the second induction coil is brought adjacent to the first induction coil 8, the second induction coil can be automatically attracted to the curtain rod 1. Therefore, the electric curtain of the present embodiment has the advantages of simple structure and convenient operation.

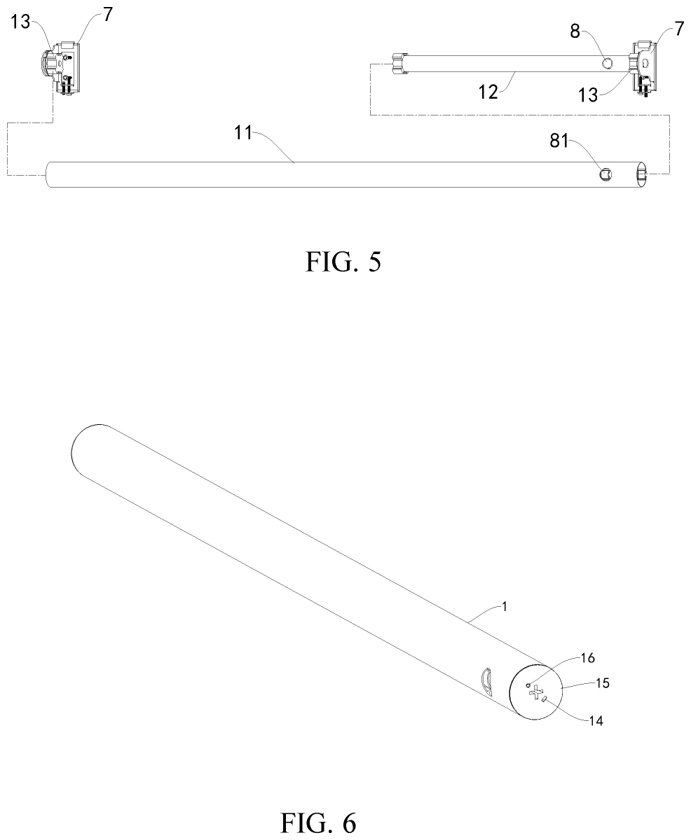

A structure of the curtain rod 1 is schematically shown in FIG. 5. As shown in FIG. 5, the curtain rod 1 includes a roller 11 and a motor 12. Both ends of the curtain rod 1 are respectively mounted on brackets 7 through bearings 13. The motor 12 is disposed in the roller 11. One terminal of the motor 12 is fixed to the bracket 7 and the motor 12 drives and cooperates with the roller 11 to provide rotational power for the roller 11.

The first induction coil 8 is fixed to the motor 12. Specifically, a hole passing through a casing may be provided on the casing of the motor 12, and the first induction coil 8 is disposed on the motor 12 corresponding to the hole.

The roller 11 is further provided with a through hole 81 at a position corresponding to the first induction coil 8.

During charging, a magnetic field generated by the second induction coil can pass through the through hole 81 and then be coupled to the first induction coil 8. The through hole 81 can reduce the loss of magnetic field energy. Especially, when the roller 11 is made of a metal material and the roller 11 is located between the first induction coil 8 and the second induction coil, a magnetic field energy can hardly be coupled from the second induction coil to the first induction coil 8. The setting of the through hole 81 effectively solves this problem. Therefore, the electric curtain of the present embodiment has the characteristics of small energy loss and high charging efficiency.

In the embodiment shown in FIG. 5, the motor 12 is a motor having a battery disposed therein, which is also referred to a battery-type motor. By adopting such type of motor, it is unnecessary to configure an independent battery, so the electric curtain of the present embodiment has the characteristics of simple internal structure and easy assembly.

It is understandable that a motor without a battery can also be used. Instead, the motor and the battery are correspondingly installed in the roller 11, and the battery and the motor are electrically connected through wires, so that the battery provides the electric energy to the motor.

A terminal structure of the curtain rod 1 is schematically shown in FIG. 6. The motor of the curtain rod 1 has a terminal, and the terminal has a first terminal surface 15. The first terminal surface 15 is specifically a terminal surface perpendicular to the rotation axis of the curtain rod 1. The first terminal surface 15 is provided with a switch 14, and the switch 14 is the power switch for the electric curtain. After the electric curtain is mounted, the power switch thereof is always on, and there is no need to operate the power switch. Therefore, disposing the power switch to the first terminal surface 15 of the motor 12 will not affect normal use. In the present embodiment, the power switch of the electric curtain is disposed on the first terminal surface 15 of the terminal of the motor. Compared with the conventional technology where the power switch is disposed on the side of the terminal of the motor, the present embodiment can reduce the length of the terminal of the motor, so it is beneficial in reducing the gap between the edge of the curtain fabric and the window frame.

In the embodiment shown in FIG. 6, the first terminal surface 15 is further provided with a network configuration key 16. Usually, in the mounting and adjustment stage of the electric curtain, the electric curtain is connected with an external device, such as a computer, through the network configuration key 16, and the adjustment of the electric curtain is made through the computer. In the present embodiment, the network configuration key 16 of the electric curtain is disposed on the first terminal surface 15 of the terminal of the motor. Compared with the conventional technology where the network configuration key is disposed on the side of the terminal of the motor, the present embodiment can reduce the length of the terminal of the motor, so it is beneficial in reducing the gap between the edge of the curtain fabric and the window frame.

As an embodiment, the electric curtain further includes an antenna for receiving a remote control signal, and the antenna is disposed at a position of the curtain rod opposite to the surface of the curtain fabric. When in use, the user sends a control instruction through a remote control. After the antenna receives the control instruction, the control instruction is transmitted to the controller in the curtain rod through the wire. The controller controls the motor to operate according to the control instruction. In the present embodiment, the user can remotely operate the electric curtain, so the electric curtain in this embodiment has the advantage of convenient operation. In addition, since the antenna for receiving remote control signals is disposed at the position of the curtain rod 1 opposite to the surface of the curtain fabric, the antenna does not occupy the terminal of the motor, so it is beneficial to reduce the length of the terminal of the motor, which is beneficial in reducing the gap between the edge of the curtain fabric and the window frame and improving the shading rate of the curtain.

The present disclosure has been described in detail through specific embodiments. These detailed descriptions are only intended to help those skilled in the art understand the content of the present disclosure and cannot be construed as limiting the scope of the present disclosure. Various modifications, equivalent transformations, etc. made to the above solutions by those skilled in the art under the concept of the present disclosure should be included in the protection scope of the present disclosure.

What is claimed is:

1. An electric curtain, comprising:
a curtain fabric, and
a curtain rod for rolling up the curtain fabric;
wherein a first induction coil is disposed at a position of the curtain rod opposite to a surface of the curtain fabric, the first induction coil is electrically connected to a battery disposed in the curtain rod, and the first induction coil is configured to be combined with a second induction coil configured with an external power supply to form an inductive charging device, so as to inductively charge the battery from the external power supply.

2. The electric curtain according to claim 1, wherein the curtain rod includes:
a roller, and
a motor disposed in the roller and configured to provide a rotational power to the roller;
wherein the first induction coil is fixed to the motor, and a position of the roller corresponding to the first induction coil is provided with a through hole.

3. The electric curtain according to claim 1, wherein the second induction coil or a carrier of the second induction coil is magnetic.

4. The electric curtain according to claim 1, wherein the first induction coil is further configured in a manner that after the electric curtain is mounted on a window frame, the first induction coil is located on a side of the curtain rod away from a wall or a side away from a glass.

5. The electric curtain according to claim 2, wherein the motor has a terminal, the terminal has a first terminal surface perpendicular to a rotation axis of the curtain rod, the electric curtain comprises a power switch, and the power switch is disposed on the first terminal surface.

6. The electric curtain according to claim 2, wherein the motor has a terminal and the terminal has a first terminal surface perpendicular to a rotation axis of the curtain rod, the electric curtain comprises a network configuration key, and the network configuration key is disposed on the first terminal surface.

7. The electric curtain according to claim 1, wherein the electric curtain comprises an antenna configured to receive a remote control signal, and the antenna is disposed at a position of the curtain rod opposite to a surface of the curtain fabric.
